(19) United States
(12) Patent Application Publication
(10) Pub. No.: US 2026/0322587 A1
(43) Pub. Date: Oct. 15, 2026

(54) MANAGING ENCRYPTED COMMUNICATION PROTOCOLS FOR NETWORK SECURITY

(71) Applicant: Cisco Technology, Inc., San Jose, CA (US)

(72) Inventors: Apoorv Raj, Nagpur (IN); Vikash Ranjan, Bengaluru (IN); David Arthur McGrew, Poolesville, MD (US); Blake Harrell Anderson, Chapel Hill, NC (US); Andrew Chi, Chapel Hill, NC (US); Durairaj Murugasamy, Bangalore (IN); Shabham Kumar Singh Rajput, Lucknow (IN)

(21) Appl. No.: 19/178,739

(22) Filed: Apr. 14, 2025

(51) Int. Cl. H04L 9/08; G06F 21/62; H04L 61/4511

(52) U.S. Cl. CPC H04L 9/0822; G06F 21/6218; H04L 61/4511

(57) ABSTRACT

Devices and methods relate to managing encrypted communication protocols for network security. A network device may include a security logic. The security logic may receive a domain name system (DNS) response including a first Encrypted Client Hello (ECH) configuration key. Based on receiving the DNS response including the first ECH configuration key, the security logic may replace the first ECH configuration key in the DNS response with a second ECH configuration key. A decryption corresponding to the second ECH configuration key may be supported at the network device. The security logic may transmit the DNS response with the second ECH configuration key. By providing the second ECH configuration key that is known to the security logic to a client device, the security logic gains visibility into one or more encrypted portions of an ECH message from the client device that follows the DNS response.

The present disclosure relates to network security systems. More particularly, the present disclosure relates to managing encrypted communication protocols for network security.

### BACKGROUND

Transport Layer Security (TLS) is a cryptographic protocol that enables secure communication between clients and servers over the internet. Traditionally, when a client initiates a TLS handshake, the client sends a Client Hello message including metadata (for example, Server Name Indication “SNI” and Application Layer Protocol Negotiation “ALPN” information), in plaintext. Firewalls and other security systems rely on these plaintext TLS Client Hello messages to extract information such as SNI and ALPN, enabling them to inspect and analyze network traffic for client identification, traffic classification, policy enforcement, or the like.

To enhance privacy and protect sensitive metadata, Encrypted Client Hello (ECH) extension has been introduced. ECH encrypts portions of the Client Hello message, for example, the SNI and ALPN, preventing passive observers and intermediaries from accessing this information. While this advancement improves privacy and mitigates certain forms of surveillance and censorship, it introduces new challenges for security systems. For example, with the adoption of ECH, firewalls and other security systems lose visibility into encrypted metadata (such as the SNI and ALPN), reducing their ability to inspect, classify, and enforce security policies effectively.

### SUMMARY OF THE DISCLOSURE

Systems and methods for managing encrypted communication protocols for network security in accordance with embodiments of the disclosure are described herein. In many embodiments, a network device may include one or more processors and a memory. The memory may be communicatively coupled to the one or more processors and may include a security logic. The security logic may be configured to receive a Domain Name System (DNS) response including a first Encrypted Client Hello (ECH) configuration key. The security logic may further be configured to replace the ECH configuration key in the DNS response with a second ECH configuration key. A decryption corresponding to the second ECH configuration key may be supported at the network device. Further, the security logic may include transmitting the DNS response with the second ECH configuration key.

In a number of embodiments, the security logic may further be configured to receive an ECH message based on the transmitted DNS response. An encryption of a portion of the ECH message may be based on the second ECH configuration key. The security logic may also be configured to decrypt the portion of the ECH message based on the support for the decryption corresponding to the second ECH configuration key.

In a variety of embodiments, the security logic may further be configured to store, in a database, a plurality of parameters associated with the received DNS response. The plurality of parameters may include the first ECH configuration key and at least one of a domain name, a public name, service binding metadata, or a client identifier specified in the received DNS response. Also, the security logic may be configured to retrieve, from the database, the first ECH configuration key, and re-encrypt the decrypted portion based on the retrieved first ECH configuration key.

In further embodiments, the security logic may further be configured to re-encrypt the decrypted portion of the ECH message based on the first ECH configuration key, replace the encrypted portion in the ECH message with the re-encrypted portion, and transmit the ECH message having the re-encrypted portion.

In still further embodiments, the security logic may further be configured to initiate a proxy connection with an upstream server. The transmission of the ECH message having the re-encrypted portion is to the upstream server over the proxy connection.

In more embodiments, the security logic may further be configured to determine that the decrypted portion of the ECH message may comply with one or more security policies. The re-encryption of the decrypted portion of the ECH message may be based on the determination that the decrypted portion of the ECH message complies with one or more security policies.

In still more embodiments, the security logic may further be configured to determine that the decrypted portion of the ECH message is non-compliant with one or more security policies, and trigger a remedial action based on the determination that the decrypted portion is non-compliant with the one or more security policies.

In additional embodiments, the remedial action may include at least one of connection termination, redirection of the ECH message to a resolver, or flagging a security alert.

In still additional embodiments, the security logic may further be configured to receive a DNS query from a client device and initiate a proxy for the received DNS query. The reception of the DNS response may be based on the initiated proxy for the received DNS query.

In numerous embodiments, the security logic may further be configured to transmit the DNS response with the second ECH configuration key to the client device in response to the received DNS query.

In several embodiments, the security logic may further be configured to determine, prior to the reception of the DNS query, that the client device supports an encrypted DNS protocol, and establish a proxy connection with the client device. The reception of the DNS query may be on the proxy connection.

In numerous additional embodiments, the encrypted DNS protocol may include at least one of DNS over Hypertext Transfer Protocol Secure (DoH) or DNS over Transport Layer Security (DoT).

In further more embodiments, the security logic may further be configured to modify a Time-to-Live (TTL) value in the received DNS response from a first value to a second. The second value may be less than the first value.

In yet more embodiments, the security logic may further be configured to disengage the proxy based on an expiration of the TTL.

In still yet more embodiments, the security logic may further be configured to receive, from a client device, an ECH message. An encryption of a portion of the ECH message may be based on the second ECH configuration key. Also, the security logic may be configured to transmit the received ECH message to an upstream server, and disengage a proxy with the client device upon the transmission of the received ECH message to the upstream server.

In many further embodiments, the received DNS response may include a first public name. The security logic may further be configured to replace the first public in the received DNS response with a second public name associated with the network device. The transmitted DNS response may include the second ECH configuration key and the second public name.

In still yet further embodiments, the network device may include at least one of a firewall or an enterprise DNS monitor.

In several additional embodiments, a network device may include one or more processors and a memory. The memory may be communicatively coupled to the one or more processors and may include a security logic. The security logic may be configured to receive a first ECH message. An encryption of a portion of the first ECH message may be based on a first ECH configuration key. The security logic may further be configured to transmit a Hello retry message including a second ECH configuration key. A decryption corresponding to the second ECH configuration key may be supported at the network device. Also, the security logic may be configured to receive a second ECH message. An encryption of a portion of the second ECH message may be based on the second ECH configuration key.

In yet several embodiments, the security logic may be further configured to decrypt the portion of the second ECH message based on the support for the decryption corresponding to the second ECH configuration key and determine that the decrypted portion of the second ECH message complies with one or more security policies. The security logic may also be configured to re-encrypt, based on the determination that the decrypted portion complies with the one or more security policies, the decrypted portion of the ECH message based on the first ECH configuration key, replace the encrypted portion in the second ECH message with the re-encrypted portion, and transmit the second ECH message having the re-encrypted portion.

In numerous other embodiments, a method may include receiving a DNS response, including a first ECH configuration key, and replacing the ECH configuration key in the DNS response with a second ECH configuration key. A decryption corresponding to the second ECH configuration key may be supported. The method may further include transmitting the DNS response with the second ECH configuration key.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram illustrating an environment for managing encrypted communication protocols for network security in accordance with various embodiments of the disclosure;

FIG. 2 is a schematic diagram illustrating an environment for managing encrypted communication protocols for network security, based on a Domain Name System (DNS) query received from a client device, in accordance with various embodiments of the disclosure;

FIG. 3 is a schematic diagram illustrating an environment for managing encrypted communication protocols for network security in response to receiving an Encrypted Client Hello (ECH) message from the client device, in accordance with various embodiments of the disclosure;

FIG. 4 is a schematic diagram illustrating an environment for disengaging proxy on encrypted communication protocols in accordance with various embodiments of the disclosure;

FIG. 5 is a flowchart depicting a process for receiving an ECH message having a portion encrypted with a second ECH configuration key in accordance with various embodiments of the disclosure;

FIG. 6 is a flowchart depicting a process for initiating a proxy connection with an upstream server in accordance with various embodiments of the disclosure is shown in accordance with various embodiments of the disclosure;

FIG. 7 is a flowchart depicting a process for transmitting a DNS response with a second ECH configuration key in accordance with various embodiments of the disclosure;

FIG. 8 is a flowchart depicting a process for transmitting an ECH message having re-encrypted portion in accordance with various embodiments of the disclosure;

FIG. 9 is a flowchart depicting a process for initiating a proxy with the client device in accordance with various embodiments of the disclosure;

FIG. 10 is a flowchart depicting a process for transmitting an ECH message to the upstream server in accordance with various embodiments of the disclosure; and

FIG. 11 is a conceptual block diagram of a network device suitable for configuration with a security logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that manage encrypted communication protocols for network security. Traditionally, firewalls and other security systems rely on plaintext Transport Layer Security (TLS) Client Hello messages to extract information for traffic analysis and security enforcement. This information may include Server Name Indication (SNI), which identifies a specific domain a client device is attempting to connect to, and Application Layer Protocol Negotiation (ALPN), which specifies a protocol the client device intends to use. By inspecting the plaintext TLS Client Hello messages, firewalls and security systems may identify client applications, classify traffic, and apply various security policies such as access control, threat detection, and anomaly monitoring.

However, with the implementation of Encrypted Client Hello (ECH), portions of the TLS Client Hello message, including the SNI and ALPN, are encrypted to enhance privacy and confidentiality. While this encryption enhances user privacy by preventing eavesdropping, it can affect the ability of firewalls and security systems to inspect and monitor network traffic. As a result, firewalls and security systems may be unable to access information, which earlier was available in plaintext, limiting their ability to identify client applications and enforce relevant security policies.

Additionally, the encryption of the TLS Client Hello message has made it more challenging for traditional security systems to execute a man-in-the-middle (MITM) proxy mechanism for comprehensive content inspection. For example, in an MITM setup, network security devices such as firewalls intercept and analyze network traffic between a client device and a destination server, enabling a thorough inspection of encrypted data, detection of potential threats, and enforcement of security policies. However, with ECH, certain portions of the Client Hello message, including the SNI and ALPN, are encrypted, preventing their inspection and rendering the MITM proxy approach ineffective.

As a result, the ability of firewalls and other security systems to perform effective traffic classification, filtering, and inspection is severely restricted. The lack of access to encrypted fields (or metadata) such as SNI and ALPN and the inability to implement MITM proxying for further content analysis renders the network vulnerable to undetected malicious activity and unauthorized access. This can compromise the integrity of security protocols by limiting the ability to inspect and enforce security policies on encrypted communications. Consequently, the capacity of firewalls and security devices to detect attacks and safeguard the network may be reduced.

Therefore, the present disclosure provides a technical solution for managing encrypted communication protocols for network security. In other words, the present disclosure provides a network device that can efficiently manage encrypted communication protocols by enabling visibility into encrypted traffic without compromising its confidentiality. In various embodiments, the network device may include one or more processors and a memory that stores a security logic. The security logic may be configured to manage encrypted communication protocols for network security. The security logic may be configured to handle ECH messages in a manner that maintains both security and confidentiality while ensuring compliance with network security protocols.

In many embodiments, the network device may receive a Domain Name System (DNS) response that includes a first ECH configuration key from a DNS server. This first ECH configuration key may be unknown to the network device. In such a case, the network device may replace the first ECH configuration key with a second ECH configuration key, which the network device supports for decryption. The network device may then transmit the modified DNS response to a client device, allowing the client device to generate an ECH message based on the second ECH configuration key. For example, the client device may encrypt a portion of the ECH message using the second ECH configuration key. This encrypted portion may include information such as the SNI and ALPN in an encrypted format. The client device can then transmit the ECH message, including the encrypted portion, to the network device. This approach may offer several advantages. For example, by replacing the unknown first ECH configuration key with the supported second ECH configuration key, the network device is able to gain visibility into the encrypted portion of the ECH message. This visibility may allow the network device to inspect, analyze, and validate the encrypted portion (for example, the SNI and ALPN) for security purposes, such as detecting potential threats or anomalies, enforcing security policies and compliance standards, or the like.

In further embodiments, upon receiving the ECH message, the network device may decrypt the encrypted portion of the ECH message using the second ECH configuration key. Based on this decryption, the network device can obtain visibility into the SNI and the ALPN. In more embodiments, the network device can analyze the decrypted portion to ensure compliance with one or more security policies. If non-compliance is detected, the network device may initiate a remedial action, such as terminating the connection, generating a security alert, or redirecting the ECH message to a resolver. In still more embodiments, the network device may re-encrypt the decrypted portion using the first ECH configuration key and generate a modified ECH message, which includes the re-encrypted portion. The network device may then forward the modified ECH message to an upstream server over a proxy connection, preserving the integrity of secure communication.

In additional embodiments, instead of providing the supported ECH configuration key to the client device in a modified DNS response, the network device can leverage Retry messages to provide the supported ECH configuration key to the client device. For example, the network device may receive a first ECH message from a client device, where a portion of the first ECH message may be encrypted using the first ECH configuration key. To facilitate continued secure communication, the network device may generate and transmit a Hello retry message to the client device. The Hello retry message may include the second ECH configuration key. The second configuration key may be supported by the network device for decryption purposes. Following the transmission of the Hello retry message, the network device may receive a second ECH message from the client device, where a portion of the second ECH message may be encrypted using the second ECH configuration key. The network device may further be configured to decrypt the encrypted portion of the second ECH message using the second ECH configuration key and inspect the decrypted portion to determine if the decrypted portion complies with the one or more security policies. If the decrypted portion complies with the one or more security policies, the network device may re-encrypt the decrypted portion using the first ECH configuration key, replacing the encrypted portion in the second ECH message with the re-encrypted portion. The network device may transmit the modified second ECH message to the upstream server, maintaining the secure communication while ensuring compliance with security standards.

Accordingly, the present disclosure enhances the ability of network devices to manage encrypted traffic, enforce security policies, and detect potential threats, all while safeguarding the confidentiality of communications. By implementing the proposed solution, network devices, such as firewalls and other security systems, can regain visibility into previously inaccessible encrypted portions of the TLS Client Hello message, improving overall network security and ensuring compliance with security standards. The present disclosure enables firewalls and security systems to effectively inspect and monitor encrypted traffic, which was previously obstructed due to the encryption of sensitive handshake data in TLS communications, such as the SNI and the ALPN.

Moreover, the proposed solution enables the implementation of an MITM proxy approach, which was previously rendered ineffective by the encryption of these handshake elements in ECH. The present disclosure ensures that security policies can be enforced even on encrypted communications by allowing the network devices to decrypt, inspect, and re-encrypt the traffic. With this functionality, firewalls and security modules can provide stronger and more comprehensive protection by enabling real-time content inspection and threat detection on encrypted connections. Accordingly, the present solution described herein supports the management of traditional network traffic and effectively addresses the challenges posed by advanced encrypted communication protocols such as ECH. This allows network devices to perform various security functions like traffic classification, threat detection, and policy enforcement while ensuring encrypted data's integrity. By re-establishing the ability to perform MITM proxying, the present disclosure enhances network security, providing a robust and effective method for safeguarding communications across increasingly encrypted networks.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In many embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in further embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

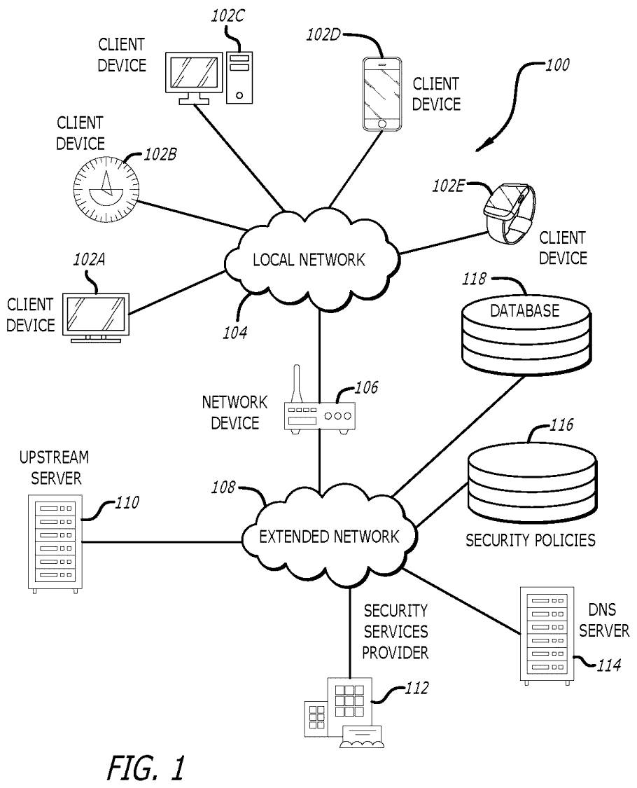

Referring to FIG. 1, a schematic diagram illustrating an environment 100 for managing encrypted communication protocols for network security in accordance with various embodiments of the disclosure is shown. In a number of embodiments, the environment 100 may include a plurality of client devices 102A, 102B, 102C, 102D, and 102E (hereinafter, collectively referred to as the “plurality of client devices 102A-E”), a local network 104, a network device 106, an extended network 108, an upstream server 110, a security services provider 112, a Domain Name System (DNS) server 114, a first database 116, and a second database 118. In many embodiments, the plurality of client devices 102A-E, the network device 106, the upstream server 110, the security services provider 112, the DNS server 114, the first database 116, and the second database 118 may be in communication with each other through the local network 104 and/or the extended network 108.

In various embodiments, the plurality of client devices 102A-E may include personal computer systems, corporate mainframe computers, mobile computing platforms (e.g., laptop computers, tablets, mobile telephones), entertainment devices (e.g., TVs, game consoles), wearable devices (e.g., smartwatches, fitness bands), household appliances (e.g., refrigerators, washing machines), and any other electronic device comprising a processor, a memory, and a communication interface. The memory may include suitable logic, circuitry, and interfaces that may be configured to store a machine code or the instructions executable by the processor. The memory may correspond to a Random Access Memory (RAM), a Read Only Memory (ROM), an Electrically Erasable Programmable Read-Only Memory (EEPROM), a Hard Disk Drive (HDD), a Solid-State Drive (SSDs), Secure Digital (SD) card, cloud-based memory, or distributed memory. Each of the plurality of client devices 102A-E may be capable of initiating and receiving encrypted communication sessions, which can be subject to security policies enforced by the network device 106.

In yet various embodiments, the local network 104 include be a Local Area Network (LAN), a home network, a corporate network, or the like. The local network 104 may connect the plurality of client devices 102A-E and other network components, enabling communication between them. The local network 104 may provide a secure environment for communication. The local network 104 may typically allow for sharing resources, such as files and Internet access, between devices and provide connectivity to external networks. Further, the extended network 108 may include a broad network infrastructure such as a Wide Area Network (WAN) and/or the Internet, providing connectivity to external services or remote servers. The extended network 108 may allow devices within the local network 104 to access resources outside the local environment, such as websites, cloud applications, or other services that are part of the broader network.

In several embodiments, the network device 106 may act as a central security gateway. The network device 106 may monitor and manage network traffic, specifically encrypted communications, to ensure compliance with security policies. The network device 106 may intercept traffic, inspect encrypted messages, enforce access control, and take corrective actions when malicious or non-compliant activity is detected. For example, the network device 106 may include at least one of a firewall or an enterprise DNS monitor. In a number of embodiments, the network device 106 may include a security logic configured to manage encrypted communication protocols for network security. The security logic can include various hardware and/or software deployments and can be configured in a variety of ways. For example, the security logic can be a set of instructions stored within a non-volatile memory that, when executed by one or more processors, can carry out the steps for managing encrypted communication protocols for network security.

In more embodiments, the upstream server 110 may be a remote server with which the plurality of client devices 102A-E may communicate to retrieve or send data. The upstream server 110 may be a part of a service, application, or website that the plurality of client devices 102A-E interact with, and the communication between the plurality of client devices 102A-E and the upstream server 110 may occur based on protocols such as Transport Layer Security (TLS) based communication protocols to protect sensitive data from unauthorized access.

In still more embodiments, the security services provider 112 may offer additional network security features, such as threat detection, network traffic analysis, and real-time security event management. The security services provider 112 may assist in identifying vulnerabilities, assessing risks, and ensuring the overall integrity of network communications. The security services provider 112 may provide services that complement those provided by the network device 106, such as cloud-based protection, security intelligence feeds, or advanced threat analytics.

In some more embodiments, the DNS server 114 may translate human-readable domain names into machine-readable Internet Protocol (IP) addresses. For example, when a client device requests to communicate with the upstream server 110, the client device may first query the DNS server 114 to obtain the corresponding IP address of the upstream server 110. The DNS server 114 may enable resolving domain names to ensure the proper routing of network traffic.

In further embodiments, the first database 116 and the second database 118 may store data that may be utilized to manage encrypted communication protocols for network security. For example, the first database 116 may store information related to the plurality of client devices 102A-E, the upstream server 110, and the DNS server 114. For example, the first database 116 may store ECH configuration keys. Further, the second database 118 may store one or more security policies. The first database 116 and the second database 118 may be utilized to ensure that network traffic is inspected correctly and that the network device 106 can enforce the one or more security policies.

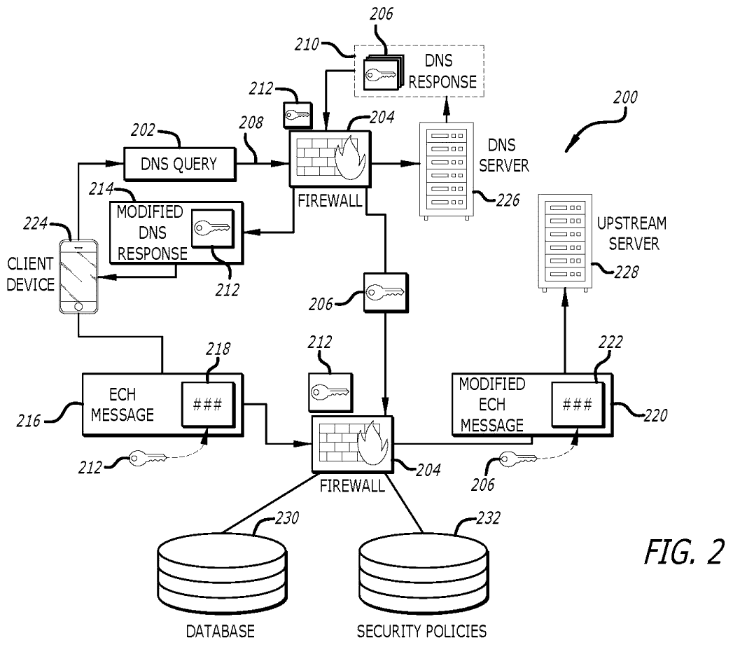

In numerous embodiments, the plurality of client devices 102A-E, the local network 104, the network device 106, the extended network 108, the upstream server 110, the security services provider 112, the DNS server 114, the first database 116, and the second database 118 may form the integrated environment 100 where encrypted communication protocols are effectively managed. The network device 106 plays a central role in monitoring and securing traffic, ensuring encrypted messages comply with security policies, and preventing unauthorized access to sensitive data. The manner in which the network device 106 manages encrypted communication protocols for network security is explained in greater detail with respect to FIG. 2-11.

Although a specific embodiment for managing encrypted communication protocols for network security suitable for carrying out the various steps, processes, methods, and operations described herein is discussed with respect to FIG. 1, any of a variety of systems and/or processes may be utilized in accordance with embodiments of the disclosure. For example, although FIG. 1 shows five client devices, there may be fewer or more than five client devices in other implementations. A detailed description is provided in the following section. The elements depicted in FIG. 1 may also be interchangeable with other elements of FIG. 2-11 as required to realize a particularly desired embodiment.

Referring to FIG. 2, a schematic diagram illustrating an environment 200 for managing encrypted communication protocols for network security, based on a DNS query received from a client device, in accordance with various embodiments of the disclosure is shown. In many embodiments, the environment 200 may include a network device (for example, a firewall 204), a client device 224, a DNS server 226, an upstream server 228, a database 230, and security policies 232. In one or more embodiments, the security policies 232 may be stored in a database, as shown in FIG. 2.

In a number of embodiments, the firewall 204 may include a security logic configured to manage encrypted communication protocols for network security. The security logic can include various hardware and/or software deployments and can be configured in a variety of ways. For example, the security logic can be a set of instructions stored within a non-volatile memory that, when executed by one or more processors, can carry out the steps for managing encrypted communication protocols for network security. For the sake of ongoing description, operations performed by the security logic are considered as performed by the firewall 204, as the security logic is included in or integrated with the firewall 204.

In a variety of embodiments, when the client device 224 intends to establish a secure TLS connection with the upstream server 228, the client device 224 may first send a DNS query 202 to the DNS server 226 to initiate a DNS resolution process. For example, through the DNS resolution process, a domain name of the upstream server 228 may be resolved to its corresponding IP address, enabling the client device 224 to determine a destination IP address of the upstream server 228 for establishing the secure TLS connection. In further embodiments, the firewall 204 may intercept the DNS query 202 to analyze and enforce one or more security policies from amongst the security policies 232 on network traffic. For example, the firewall 204 may receive the DNS query 202 based on the interception. In still further embodiments, before receiving the DNS query 202, the firewall 204 may determine whether the client device 224 supports an encrypted DNS protocol. The encrypted DNS protocol may include at least one of DNS over Hypertext Transfer Protocol Secure (DoH) or DNS over Transport Layer Security (DoT). If it is determined that the client device 224 supports the encrypted DNS protocol, the firewall 204 may be configured to establish a proxy connection 208 with the client device 224. For example, the firewall 204 may receive the DNS query 202 through the proxy connection 208. In an example, the firewall 204 may act as an intermediary between the client device 224 and the DNS server 226, thereby handling the DNS query 202 on behalf of the client device 224. For example, instead of the client device 224 sending the DNS query 202 directly to the DNS server 226, the firewall 204 may intercept and receive the DNS query 202.

In more embodiments, the firewall 204 may initiate a proxy for the received DNS query 202. In this scenario, the firewall 204 may receive a DNS response 210 from the DNS server 226 as a result of intercepting the DNS query 202. For example, the DNS response 210 may include a first ECH configuration key 206, which may not be known to the firewall 204. The reception of the DNS response 210 may be based on the initiated proxy for the received DNS query 202. In still more embodiments, the firewall 204 may be configured to store a plurality of parameters associated with the received DNS response 210 in the database 230. In a non-limiting example, the plurality of parameters may include the first ECH configuration key 206 and at least one of the domain name, a public name, service binding metadata, or a client identifier specified in the received DNS response 210.

The first ECH configuration key 206 may be used to encrypt a portion of a Client Hello message during a TLS handshake between the client device 224 and the upstream server 228, ensuring that sensitive information, such as an identity of the upstream server 228 (typically conveyed via Server Name Indication “SNI”) and the preferred TLS protocols of the client device 224 (negotiated through Application Layer Protocol Negotiation “ALPN”), remains confidential. By using ECH, the SNI and ALPN information are protected from being visible to attackers or intermediaries (such as the firewall 204). In an example, the first ECH configuration key 206 may be part of a public-private key pair. Specifically, the first ECH configuration key 206 could be the public key, corresponding to a private key held by the DNS server 226 and/or the upstream server 228, which is required for subsequent secure communication.

However, for security reasons, the firewall 204 may need to inspect the encrypted portion of the Client Hello message. Since the first ECH configuration key 206 is unknown to the firewall 204, the firewall 204 cannot inspect the encrypted portion of the Client Hello message. To enable the firewall 204 to inspect and decrypt the encrypted portion of the Client Hello message, and further read the sensitive information, in several embodiments, the firewall 204 may replace the first ECH configuration key 206 in the DNS response 210 with a second ECH configuration key 212, which is known to the firewall 204. In an example, the second ECH configuration key 212 may be part of a public-private key pair. Specifically, the second ECH configuration key 212 could be the public key, corresponding to a private key held by the firewall 204. For example, a decryption corresponding to the second ECH configuration key 212 may be supported at the firewall 204. By replacing the first ECH configuration key 206 with the second ECH configuration key 212, the firewall 204 may be able to decrypt and analyze a Client Hello message to determine whether the decrypted Client Hello message complies with one or more security policies from amongst the security policies 232. Based on the analysis, the firewall 204 may trigger a remedial action.

In additional embodiments, the firewall 204 may transmit the DNS response 214 with the second ECH configuration key 212 (also referred to as “the modified DNS response 214”) to the client device 224. The client device 224 may then generate an ECH message 216 using the second ECH configuration key 212. For example, portion 218 of the ECH message 216 may be encrypted using the second ECH configuration key 212. The portion 218 may interchangeably be referred to as an encrypted portion 218. In this example, the encryption of the portion 218 of the ECH message 216 may be based on the second ECH configuration key 212. The portion 218 may include sensitive information in an encrypted format, such as the identity of the upstream server 228 and preferred TLS protocols of the client device 224.

In still additional embodiments, the client device 224 may initiate a TLS handshake with the upstream server 228 using the ECH message 216. The firewall 204 may intercept the ECH message 216. The firewall 204 may receive the ECH message 216 based on the transmitted DNS response 210. For example, the firewall 204 may receive the ECH message 216 as a result of the interception. In numerous embodiments, the firewall 204 may decrypt the portion 218 of the ECH message 216 based on the support for the decryption corresponding to the second ECH configuration key 212. The firewall 204 may determine whether the decrypted portion of the ECH message 216 complies with one or more security policies from amongst the security policies 232. In one example, a security policy may require that retrieved SNI match a predefined list of trusted domain names. In another example, a security policy may mandate that an ALPN field indicate a supported protocol version to ensure network compatibility and security.

Upon determining that the decrypted portion of the ECH message 216 is non-compliant with the one or more security policies from amongst the security policies 232, the firewall 204 may trigger a remedial action based on the determination that the decrypted portion is non-compliant with the one or more security policies from amongst the security policies 232. The remedial action may include at least one of connection termination, redirection of the ECH message 216 to a resolver, or flagging a security alert.

In numerous additional embodiments, if the firewall 204 determines that the decrypted portion of the ECH message 216 complies with the one or more security policies from amongst the security policies 232, the firewall 204 may retrieve the first ECH configuration key 206 from the database 230. Further, the firewall 204 may re-encrypt the decrypted portion of the ECH message 216 based on the retrieved first ECH configuration key 206. The firewall 204 may replace the encrypted portion 218 in the ECH message 216 with the re-encrypted portion 222. The firewall 204 may generate a modified ECH message 220 including the re-encrypted portion 222.

In further more embodiments, the firewall 204 may initiate a proxy connection with the upstream server 228. The firewall 204 may transmit the modified ECH message 220 having the re-encrypted portion 222 to the upstream server 228. In many additional embodiments, the firewall 204 may disengage a proxy with the client device 224 upon the transmission of the modified ECH message 220 to the upstream server 228.

Accordingly, the present disclosure enables visibility into ECH messages, which were previously challenging to inspect due to encryption. Restoring this visibility allows the firewall 204 to more effectively monitor encrypted traffic, enhancing its ability to detect potential threats and enforce security policies 232. With this improved visibility, network security is improved by ensuring that encrypted data complies with security standards, identifying vulnerabilities, and enabling proactive measures to prevent malicious activity. Thus, network security is enhanced by providing deeper insights into encrypted traffic while preserving the integrity and privacy of the communication.

In many additional embodiments, to ensure that encrypted traffic is appropriately managed and potential security threats are identified, the firewall 204 may be further configured to monitor DNS connections and ECH configurations. For example, when a client device initiates a TLS connection with ECH enabled, a DNS query of the client device retrieves a DNS response containing an ECH configuration key from a DNS server. Monitoring such DNS connections and ECH configurations can reveal which servers are configured to support ECH and help identify the domains associated with those ECH configurations. In an example, a company's security team may want to track which domains support ECH to ensure that sensitive data exchanges remain encrypted. Thus, by maintaining a watchlist of domains that return ECH parameters in their DNS responses, one or more patterns in ECH adoption can be observed and a decision on whether proxy intervention is required or not may be taken. If a particular domain starts using ECH unexpectedly or changes its encryption parameters, the firewall 204 can adjust security policies accordingly. In further additional embodiments, modifying a DNS response can be utilized as a proactive measure. For example, if the firewall 204 identifies a domain that utilizes outdated or insecure ECH configurations, the firewall 204 may modify DNS responses to redirect traffic through a monitoring proxy.

Although a specific embodiment for managing encrypted communication protocols for network security based on a DNS query received from a client device suitable for carrying out the various steps, processes, methods, and operations described herein is discussed with respect to FIG. 2, any of a variety of systems and/or processes may be utilized in accordance with embodiments of the disclosure. For example, the received DNS response 210 may include a first public name. In one or more embodiments, the firewall 204 may replace the first public in the received DNS response 210 with a second public name associated with the firewall 204. In such scenario, the transmitted DNS response 214 may include the second ECH configuration key 212 and the second public name. A detailed description is provided in the following section. The elements depicted in FIG. 2 may also be interchangeable with other elements of FIG. 1 and FIG. 3-11 as required to realize a particularly desired embodiment.

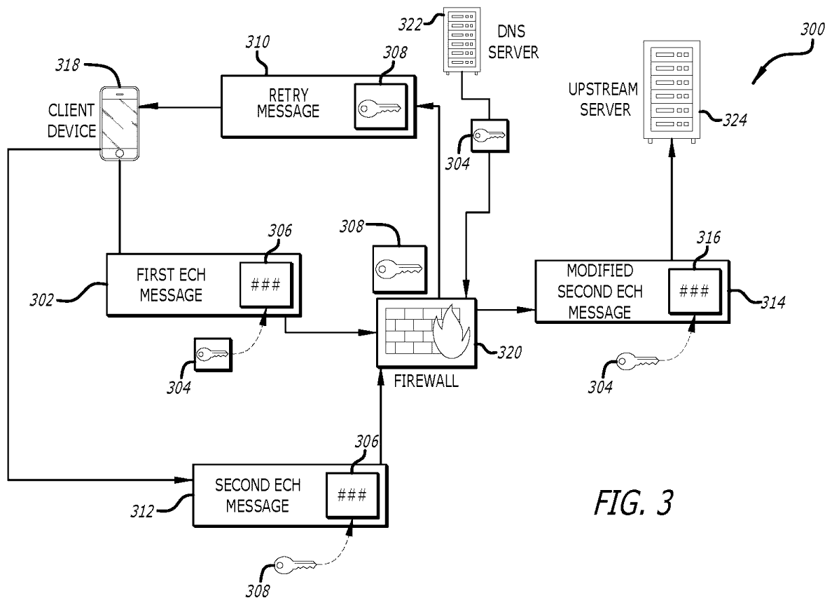

Referring to FIG. 3, a schematic diagram illustrating an environment 300 for managing encrypted communication protocols for network security in response to receiving an ECH message from a client device in accordance with various embodiments of the disclosure is shown. In many embodiments, the environment 300 may include a client device 318, a network device (for example, a firewall 320), a DNS server 322, and an upstream server 324.

In a number of embodiments, the firewall 320 may include a security logic configured to manage encrypted communication protocols for network security. The security logic can include various hardware and/or software deployments and can be configured in a variety of ways. For example, the security logic can be a set of instructions stored within a non-volatile memory that, when executed by one or more processors, can carry out the steps for managing encrypted communication protocols for network security. For the sake of ongoing description, operations performed by the security logic are considered as performed by the firewall 320, as the security logic is included in or integrated with the firewall 320.

In a variety of embodiments, the client device 318 may initiate a TLS handshake with the upstream server 324 using a first ECH message 302. The first ECH message 302 may include a first ECH configuration key 304 and an encrypted portion 306. The first ECH configuration key 304 may be provided by the DNS server 322. In an example, an encryption of the encrypted portion 306 of the first ECH message 302 may be based on the first ECH configuration key 304. In a non-limiting example, the encrypted portion 306 may include information such as SNI and/or ALPN in an encrypted format. In several embodiments, the firewall 320 may intercept the first ECH message 302. For example, the firewall 320 may receive the first ECH message 302 as a result of the interception. In an example, the first ECH configuration key 304 may be unknown to the firewall 320, preventing the firewall 320 from decrypting the first ECH message 302.

In several more embodiments, upon receiving the first ECH message 302, the firewall 320 may generate a retry message 310 (e.g., a Hello retry message) having a second ECH configuration key 308 (for example, a known key). Accordingly, the retry message 310 may include the second ECH configuration key 308. The firewall 320 may then transmit the retry message 310 to the client device 318.

In yet several embodiments, the client device 318 may transmit a second ECH message 312 to the upstream server 324 which the firewall 320 may be able to intercept, based on the retry message 310. The second ECH message 312 may include the encrypted portion 306 and the second ECH configuration key 308. In an example, an encryption of the encrypted portion 306 of the second ECH message 312 may be based on the second ECH configuration key 308. Upon intercepting the second ECH message 312, the firewall 320 may decrypt the encrypted portion 306 of the second ECH message 312 based on the support for the decryption corresponding to the second ECH configuration key 308. In still yet more embodiments, the firewall 320 may determine that the decrypted portion of the second ECH message 312 complies with one or more security policies. Further, the firewall 320 may re-encrypt, based on the determination that the decrypted portion complies with the one or more security policies, the decrypted portion of the second ECH message 312 based on the first ECH configuration key 304. In yet further embodiments, the firewall 320 may generate a modified second ECH message 314 based on replacing the encrypted portion 306 in the second ECH message 312 with re-encrypted portion 316. For example, the modified second ECH message 314 may include the first ECH configuration key 304 and the re-encrypted portion 316. The firewall 320 may transmit the modified second ECH message 314 having the re-encrypted portion 316 to the upstream server 324.

Accordingly, the firewall 320 is enabled to gain full visibility into the TLS Client Hello, allowing the firewall 320 to inspect handshake information that was previously encrypted and hidden. This enhanced visibility ensures the firewall 320 can effectively monitor and enforce security policies on encrypted traffic. Additionally, the firewall 320 is capable of managing a proxy connection to the upstream server 324, facilitating further content inspection.

Although a specific embodiment for managing encrypted communication protocols for network security in response to receiving an ECH message from a client device suitable for carrying out the various steps, processes, methods, and operations described herein is discussed with respect to FIG. 3, any of a variety of systems and/or processes may be utilized in accordance with embodiments of the disclosure. For example, the first ECH configuration key 304 may be received as part of a DNS response (e.g., a response to a DNS query) from the DNS server 322. In response to receiving the DNS response, the client device 318 may generate the first ECH message 302 using the first ECH configuration key 304. A detailed description is provided in the following section. The elements depicted in FIG. 3 may also be interchangeable with other elements of FIG. 1-2 and FIG. 3-11 as required to realize a particularly desired embodiment.

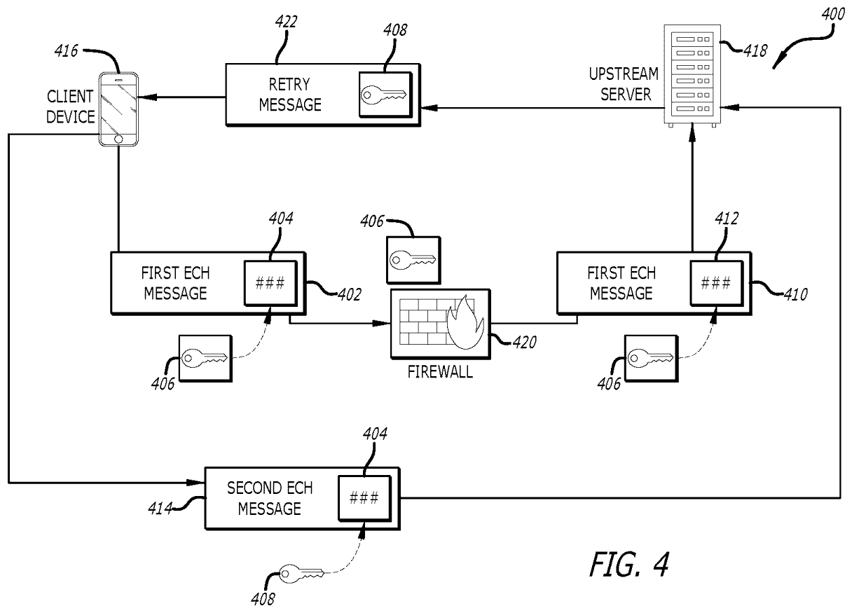

Referring to FIG. 4, a schematic diagram illustrating an environment 400 for disengaging proxy on encrypted communication protocols with various embodiments of the disclosure is shown. In many embodiments, the environment 400 may include a client device 416, an upstream server 418, and a network device (for example, a firewall 420 as shown in FIG. 4).

In various embodiments, the firewall 420 may include a security logic configured to manage encrypted communication protocols for network security. The security logic can include various hardware and/or software deployments and can be configured in a variety of ways. For example, the security logic can be a set of instructions stored within a non-volatile memory that, when executed by one or more processors, can carry out the steps for managing encrypted communication protocols for network security. For the sake of ongoing description, operations performed by the security logic are considered as performed by the firewall 420, as the security logic is included in or integrated with the firewall 420.

In more embodiments, the client device 416 may initiate a TLS handshake with the upstream server 418 using a first ECH message 402. The first ECH message 402 may include a second ECH configuration key 406 and an encrypted portion 404. In an example, an encryption of the encrypted portion 404 of the first ECH message 402 may be based on the second ECH configuration key 406. In a non-limiting example, the encrypted portion 404 may include information such as SNI and/or ALPN in an encrypted format. In still more embodiments, the client device 416 may transmit the first ECH message 402 to the upstream server 418. In one or more embodiments, the firewall 420 may intercept the first ECH message 402. For example, the firewall 420 may receive the first ECH message 402 from the client device 416 due to interception.

In some more embodiments, upon receiving the first ECH message 402, the firewall 420 may decrypt the encrypted portion 404 using the second ECH configuration key 406. Upon decrypting the encrypted portion 404, the firewall 420 may determine that the decrypted portion complies with one or more security policies. The firewall 420 may re-encrypt the decrypted portion using the second ECH configuration key 406. Further, the firewall 420 may generate a modified first ECH message 410 having the re-encrypted portion 412 and the second ECH configuration key 406. In yet more embodiment, the firewall 420 may transmit the modified first ECH message 410 having the re-encrypted portion 412 and the second ECH configuration key 406 to the upstream server 418 and disengage a proxy with the client device 416 upon the transmission of the modified first ECH message 410 to the upstream server 418. Alternatively, if no action is required, the firewall 420 may forward the original first ECH message 402 to the upstream server 418 without modification and disengage the proxy with the client device 416 upon the transmission of the received first ECH message 410 to the upstream server 418.

In an example, the second ECH configuration key 406 may be unknown to the upstream server 418. In such cases, the upstream server 418 may respond with a retry message 422, which includes a first ECH configuration key 408 intended for the client device 416. Upon receiving the retry message 422, the client device 416 may generate a second ECH message 414, which contains an encrypted portion 404 based on the first ECH configuration key 408. The client device 416 may then transmit the second ECH message 414 to the upstream server 418.

The ability to generate the modified first ECH message 410 and handle the retry message 422 from the upstream server 418 ensures uninterrupted, secure communication while maintaining compliance with security standards. Consequently, network security is enhanced by enabling the firewall 420 to gain visibility into encrypted traffic without compromising confidentiality, thereby allowing the firewall 420 to detect threats and enforce security policies across encrypted connections proactively.

Although a specific embodiment for managing encrypted communication protocols for network security based on a retry message suitable for carrying out the various steps, processes, methods, and operations described herein is discussed with respect to FIG. 4, any of a variety of systems and/or processes may be utilized in accordance with embodiments of the disclosure. For example, upon decrypting the encrypted portion 404, if it is determined that the decrypted portion does not comply with the one or more security policies, the firewall 420 may trigger a remedial action. The remedial action may include at least one of connection termination, redirection of the first ECH message 402 to a resolver, or flagging a security alert. A detailed description is provided in the following section. The elements depicted in FIG. 4 may also be interchangeable with other elements of FIG. 1-3 and FIG. 4-11 as required to realize a particularly desired embodiment.

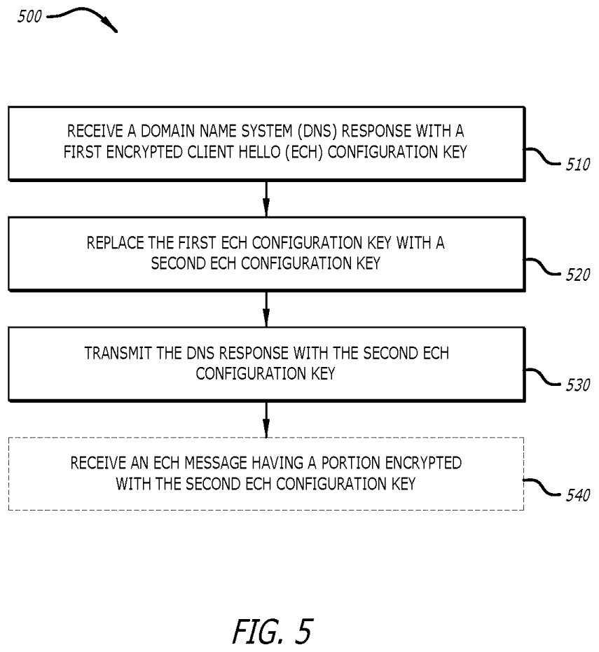

Referring to FIG. 5, a flowchart depicting a process 500 for receiving an ECH message having a portion encrypted with a second ECH configuration key in accordance with various embodiments of the disclosure is shown. In several embodiments, the process 500 may be implemented in a network device. For example, the network device may include at least one of a firewall or an enterprise DNS monitor.

In many embodiments, the process 500 may receive a DNS response with a first ECH configuration key (block 510). For example, the process 500 may receive the DNS response from a DNS server. In a number of embodiments, before receiving the DNS response, the process 500 may receive a DNS query from a client device. In response to receiving the DNS query, the process 500 may initiate a proxy for the received DNS query. For example, the reception of the DNS response may be based on the initiated proxy for the received DNS query.

In various embodiments, the process 500 may replace the first ECH configuration key with a second ECH configuration key (block 520). In an example, a decryption corresponding to the second ECH configuration key may be supported at the network device. The process 500 may replace the first ECH configuration key with the second ECH configuration key to manage network security. This involves identifying potential security threats, checking for non-compliance with one or more security policies, and/or triggering remedial actions based on the determination of non-compliance with the one or more security policies.

In yet various embodiments, the process 500 may transmit the DNS response with the second ECH configuration key (block 530). The process 500 may transmit the DNS response with the second ECH configuration key to the client device. In an example, the process 500 may transmit the DNS response with the second ECH configuration key to the client device in response to the received DNS query.

In some more embodiments, the process 500 may receive an ECH message having a portion encrypted with the second ECH configuration key (block 540). The process 500 may receive the ECH message based on the transmitted DNS response. For example, the process 500 may receive the ECH message from the client device. In further embodiments, the process 500 may decrypt the portion of the ECH message based on the support for the decryption corresponding to the second ECH configuration key. The process 500 may then determine whether the decrypted portion of the ECH message complies with the one or more security policies. In response to the determination that the decrypted portion is non-compliant with the one or more security policies, the process 500 may trigger a remedial action for network security. In a non-limiting example, the remedial action may include at least one of a connection termination, a redirection of the ECH message to a resolver, or flagging a security alert. In one or more embodiments, the receiving of the ECH message having the portion encrypted with the second ECH configuration key may be optional.

Although a specific embodiment for receiving the ECH message having the portion encrypted with the second ECH configuration key suitable for carrying out the various steps, processes, methods, and operations described herein is discussed with respect to FIG. 5, any of a variety of systems and/or processes may be utilized in accordance with embodiments of the disclosure. For example, the DNS response may include multiple ECH configuration keys. In such a scenario, the process 500 may replace each ECH configuration key with its corresponding ECH configuration key. The elements depicted in FIG. 5 may also be interchangeable with other elements of FIG. 1-4 and FIG. 6-11 as required to realize a particularly desired embodiment.

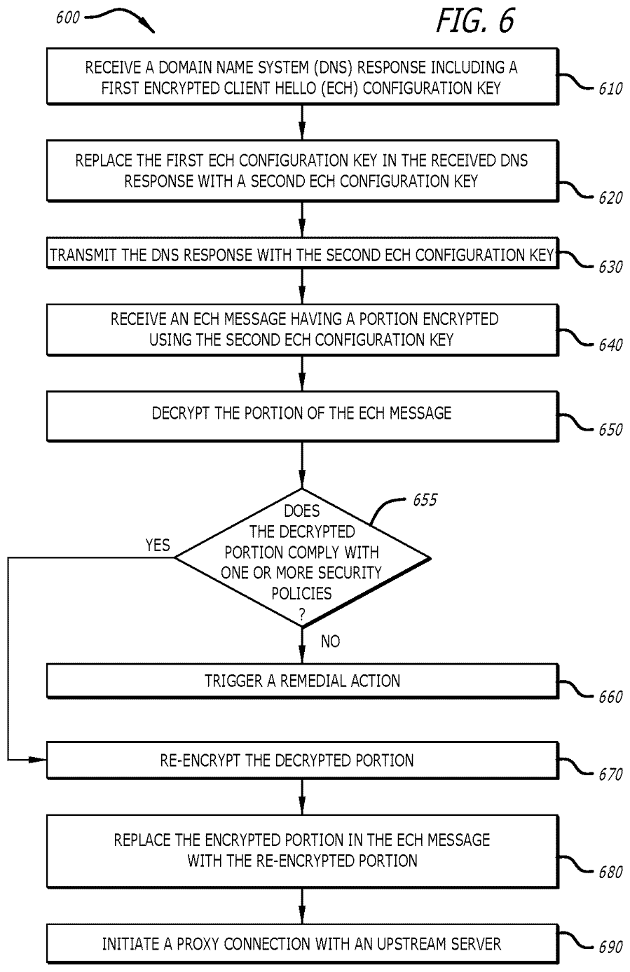

Referring to FIG. 6, a flowchart depicting a process 600 for initiating a proxy connection with an upstream server in accordance with various embodiments of the disclosure is shown. In many embodiments, the process 600 may be implemented in a network device. For example, the network device may include at least one of a firewall or an enterprise DNS monitor.

In several embodiments, the process 600 may receive a DNS response including a first ECH configuration key (block 610). For example, the process 600 may receive the DNS response from a DNS server. In a number of embodiments, before receiving the DNS response, the process 600 may receive a DNS query from a client device. In response to receiving the DNS query, the process 600 may initiate a proxy for the received DNS query. In an example, the reception of the DNS response may be based on the initiated proxy for the received DNS query.

In several additional embodiments, the process 600 may replace the first ECH configuration key in the received DNS response with a second ECH configuration key (block 620). In an example, a decryption corresponding to the second ECH configuration key may be supported at the network device. The process 600 may replace the first ECH configuration key with the second ECH configuration key for managing network security. This involves identifying potential security threats, checking for non-compliance with one or more security policies, and/or triggering remedial actions based on the determination of non-compliance with the one or more security policies.

In many further embodiments, the process 600 may transmit the DNS response with the second ECH configuration key (block 630). The process 600 may transmit the DNS response with the second ECH configuration key to the client device. In an example, the process 600 may transmit the DNS response with the second ECH configuration key to the client device in response to the received DNS query.

In yet many embodiments, the process 600 may receive an ECH message having a portion encrypted using the second ECH configuration key (block 640). The process 600 may receive the ECH message based on the transmitted DNS response. For example, the process 600 may receive the ECH message from the client device. For example, the ECH message may include one or more encrypted fields, such as an encrypted SNI field, an encrypted ALPN field, or the like. The encrypted SNI field may specify an SNI in an encrypted format, and the encrypted ALPN field may specify the ALPN in an encrypted format.

In yet more embodiments, the process 600 may decrypt the portion of the ECH message (block 650). The process 600 may decrypt the portion of the ECH message based on the support for the decryption corresponding to the second ECH configuration key. For example, process 600 may decrypt the ECH message using the second ECH configuration key and retrieve information, such as the SNI and/or the ALPN, that was originally encrypted.

In still various embodiments, the process 600 may determine whether the decrypted portion complies with one or more security policies (block 655). In an example, a security policy may require that the retrieved SNI match a predefined list of trusted domain names. In another example, a security policy may specify that the ALPN field must indicate a supported protocol version to ensure network compatibility and security.

In yet further embodiments, if it is determined that the decrypted portion of the ECH message does not comply with the one or more security policies, the process 600 may trigger a remedial action (block 660). For example, the remedial action may include at least one of connection termination, redirection of the ECH message to a resolver, or flagging a security alert. In an example, in response to determining that the decrypted portion of the ECH message does not comply with the one or more security policies, the process 600 may redirect the ECH message to the resolver for further analysis. In another example, in response to determining that the decrypted portion of the ECH message does not comply with the one or more security policies, the process 600 may flag the security alert to notify an administrator of a potential issue.

In yet many further embodiments, if it is determined that the decrypted portion of the ECH message complies with the one or more security policies, the process 600 may re-encrypt the decrypted portion (block 670). The process 600 may re-encrypt the decrypted portion of the ECH message based on the first ECH configuration key. For example, if it is determined that the decrypted portion of the ECH message complies with one or more security policies, process 600 may retrieve the first ECH configuration key from a database. The process 600 may then re-encrypt the decrypted portion of the ECH message based on the retrieved first ECH configuration key. This ensures that the ECH message remains protected prior to transmission to an intended recipient.

In still yet various embodiments, the process 600 may replace the encrypted portion in the ECH message with the re-encrypted portion (block 680). This ensures that the information related to the SNI and/or ALPN remains securely encrypted before the ECH message is sent to its intended recipient. Furthermore, by replacing the original encrypted portion with the re-encrypted one, the process 600 may effectively restore the confidentiality of the ECH message, ensuring that only authorized parties can access its content. In doing so, the process 600 maintains security throughout the transmission, even after the message has been decrypted for the security policy compliance check.

In yet many additional embodiments, the process 600 may initiate a proxy connection with an upstream server (block 690). For example, the process 600 may transmit the ECH message, with the re-encrypted portion, to the upstream server over the proxy connection. By using the proxy connection, the process 600 may ensure that the ECH message is sent to the upstream server securely, facilitating further processing or handling while maintaining the confidentiality of the encrypted information throughout the transmission.

Although a specific embodiment for initiating the proxy connection with the upstream server suitable for carrying out the various steps, processes, methods, and operations described herein is discussed with respect to FIG. 6, any of a variety of systems and/or processes may be utilized in accordance with embodiments of the disclosure. For example, the process 600 may store the first ECH configuration key in a database for future retrieval. The elements depicted in FIG. 6 may also be interchangeable with other elements of FIG. 1-5 and FIG. 7-11 as required to realize a particularly desired embodiment.

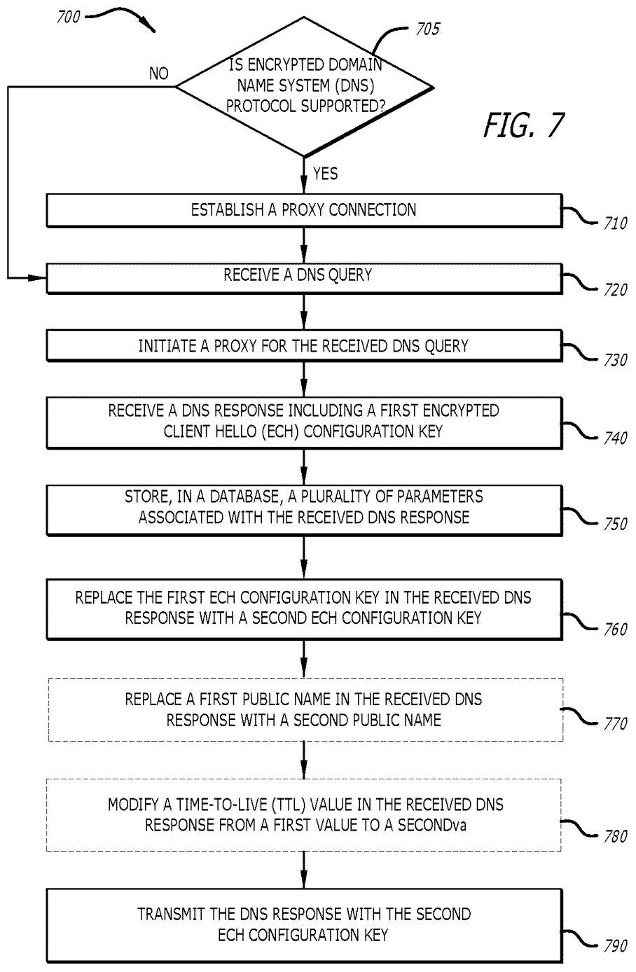

Referring to FIG. 7, a flowchart depicting a process 700 for transmitting a DNS response with a second ECH configuration key in accordance with various embodiments of the disclosure is shown. In many embodiments, the process 700 may be implemented in a network device. For example, the network device may include at least one of a firewall or an enterprise DNS monitor.

In many embodiments, the process 700 may determine whether a client device supports an encrypted DNS protocol (block 705). In one example, the encrypted DNS protocol may include DNS over Hypertext Transfer Protocol Secure (DoH). In another example, the encrypted DNS protocol may include DNS over Transport Layer Security (DoT).

In several embodiments, if it is determined that the client device supports the encrypted DNS protocol, the process 700 may establish a proxy connection (block 710). For example, the process 700 may establish the proxy connection with the client device. The process 700 may establish the proxy connection for secure data exchange with the client device. The proxy connection enables the encrypted DNS protocol to be fully utilized, enhancing privacy and security for the client device.

In various embodiments, if it is determined that the client device does not support the encrypted DNS protocol, the process 700 may receive a DNS query (block 720). The process 700 may receive the DNS query from the client device. For example, the process 700 may receive the DNS query over an unencrypted connection. In many examples, the DNS query may be received on the proxy connection.

In yet various embodiments, the process 700 may initiate a proxy for the received DNS query (block 730). In one or more embodiments, the process 700 may forward or relay the received DNS query to an external DNS server using the initiated proxy. By using the proxy, the process 700 may enhance the security and/or reliability of the DNS query exchange, even if the client device does not support the encrypted DNS protocol.

In some more embodiments, the process 700 may receive a DNS response including a first ECH configuration key (block 740). The process 700 may receive the DNS response from the external DNS server. For example, the reception of the DNS response may be based on the initiated proxy for the received DNS query.

In many further embodiments, the process 700 may store, in a database, a plurality of parameters associated with the received DNS response (block 750). In an example, the plurality of parameters may include the first ECH configuration key. Additionally, the plurality of parameters may include at least one of a domain name, a public name, service binding metadata, or a client identifier specified in the received DNS response. By storing the plurality of parameters in the database, the process 700 may ensure that information related to the DNS response is available for future actions, such as processing subsequent DNS queries, re-encrypting messages, and/or validating the information against one or more security policies.

In yet many embodiments, the process 700 may replace the first ECH configuration key in the received DNS response with a second ECH configuration key (block 760). The process 700 may replace the first ECH configuration key with the second ECH configuration key for managing network security. This involves identifying potential security threats, checking for non-compliance with the one or more security policies, and/or triggering remedial actions based on the determination of non-compliance with the one or more security policies.

In yet more embodiments, the process 700 may replace a first public name in the received DNS response with a second public name (block 770). The first public name may correspond to a domain or service that the client device is attempting to access. In an example, the second public name may be associated with the network device. In yet many embodiments, the replacement of the first public name in the received DNS response with the second public name may be optional.

In several more embodiments, the process 700 may modify a Time-To-Live (TTL) value in the received DNS response from a first value to a second value (block 780). In an example, the second value may be less than the first value. In various embodiments, the modification of the TTL value in the received DNS response from the first value to the second value may be optional.

In yet many additional embodiments, the process 700 may transmit the DNS response with the second ECH configuration key (block 790). The process 700 may transmit the DNS response with the second ECH configuration key to the client device. In an example, the process 700 may transmit the DNS response with the second ECH configuration key to the client device in response to the received DNS query.

Although a specific embodiment for transmitting the DNS response with the second ECH configuration key suitable for carrying out the various steps, processes, methods, and operations described herein is discussed with respect to FIG. 7, any of a variety of systems and/or processes may be utilized in accordance with embodiments of the disclosure. For example, the process 700 may disengage the proxy based on an expiration of the TTL. The specific features and functions described herein are not intended to be limiting to this specific embodiment. Additionally, the elements depicted in FIG. 7 may also be interchangeable with other elements of FIG. 1-6 and FIG. 8-11 as required to realize a particularly desired embodiment.

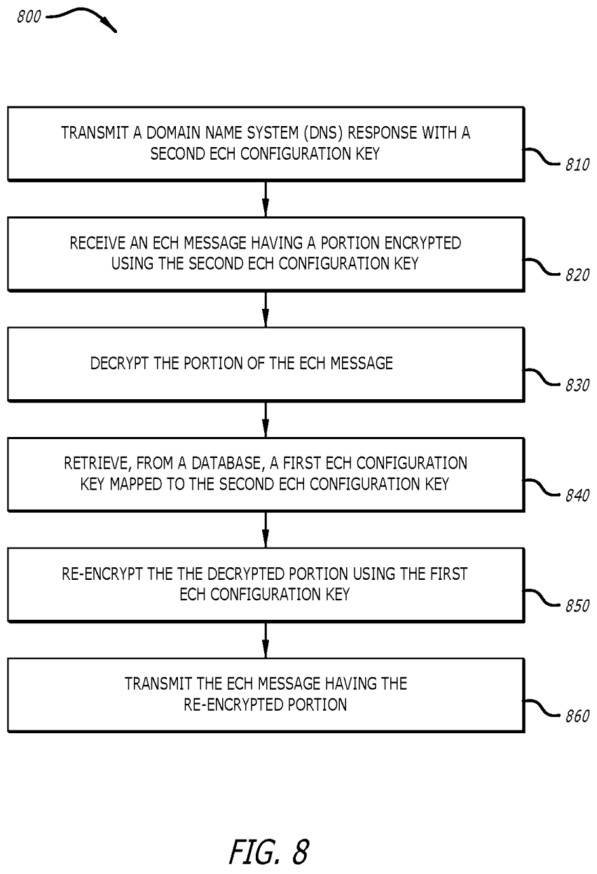

Referring to FIG. 8, a flowchart depicting a process 800 for transmitting an ECH message having re-encrypted portion in accordance with various embodiments of the disclosure is shown. In many embodiments, the process 800 may be implemented in a network device. For example, the network device may include at least one of a firewall or an enterprise DNS monitor.

In a variety of embodiments, the process 800 may transmit a DNS response with a second ECH configuration key (block 810). The process 800 may transmit the DNS response with the second ECH configuration key to the client device. For example, the process 800 may receive a DNS query from a client device. Further, the process 800 may initiate a proxy for the received DNS query. The process 800 may then receive a DNS response including a first ECH configuration key. The process 800 may store the first ECH configuration key in a database. The process 800 may replace the ECH configuration key in the DNS response with the second ECH configuration key and transmit the DNS response with the second ECH configuration key to the client device.

In several embodiments, the process 800 may receive an ECH message having a portion encrypted with the second ECH configuration key (block 820). The process 800 may receive the ECH message based on the transmitted DNS response. For example, the process 800 may receive the ECH message from the client device. For example, the ECH message may include one or more encrypted fields, such as an encrypted SNI field, an encrypted ALPN field, or similar encrypted fields. The encrypted SNI field may specify an SNI in an encrypted format, and the encrypted ALPN field may specify the ALPN in an encrypted format.

In yet more embodiments, the process 800 may decrypt the portion of the ECH message (block 830). The process 800 may decrypt the portion of the ECH message based on the support for the decryption corresponding to the second ECH configuration key. For example, the process 800 may decrypt the ECH message using the second ECH configuration key and retrieve information, such as the SNI and/or the ALPN, that was originally encrypted.

In still more embodiments, the process 800 may retrieve, from a database, a first ECH configuration key mapped to the second ECH configuration key (block 840). The first ECH configuration key may originally be received as part of a DNS response from a DNS server. The first ECH configuration key may be used to encrypt one or more portions of the ECH message. Once the first ECH configuration key is received as part of the DNS response, the first ECH configuration key may be stored in the database and mapped to the second ECH configuration key.

In yet further embodiments, the process 800 may re-encrypt the de-crypted portion using the first ECH configuration key (block 850). The process 800 may further replace the encrypted portion in the ECH message with the re-encrypted portion. As a result, the ECH message may retain security protections while conforming to the expected encryption parameters of the network.

In yet many additional embodiments, the process 800 may transmit the ECH message having the re-encrypted portion (block 860). The process 800 may transmit the ECH message to an upstream server. The process 800 ensures that the ECH message is securely delivered to the upstream server while maintaining the required encryption standards. This facilitates a seamless and protected communication process between the client device and the upstream server.

Although a specific embodiment of the process transmitting an ECH message having re-encrypted portion suitable for carrying out the various steps, processes, methods, and operations described herein is discussed with respect to FIG. 8, any of a variety of systems and/or processes may be utilized in accordance with embodiments of the disclosure. For example, the process 800 may transmit the ECH message to the upstream server over a proxy connection. The elements depicted in FIG. 8 may also be interchangeable with other elements of FIG. 1-7 and FIG. 9-11 as required to realize a particularly desired embodiment.

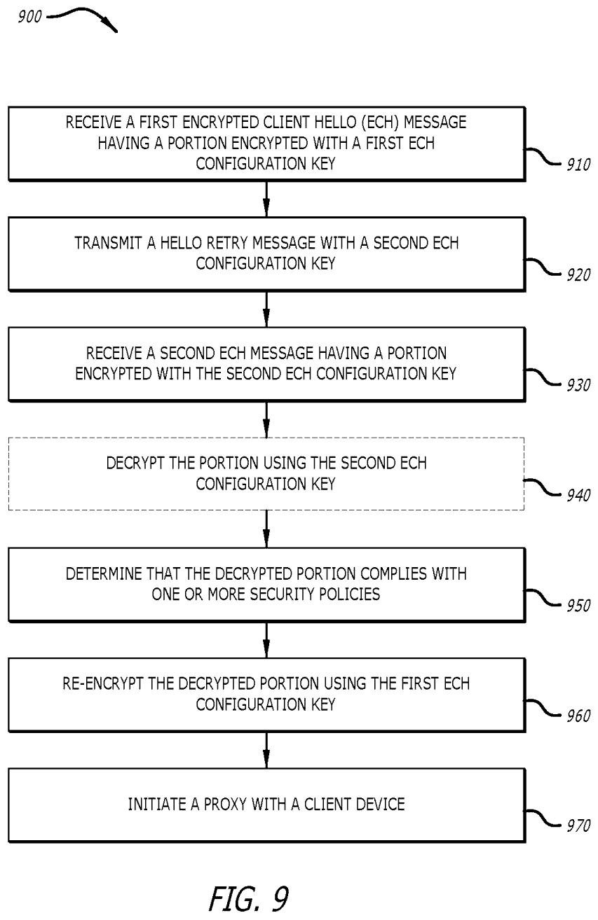

Referring to FIG. 9, a flowchart depicting a process 900 for initiating a proxy with a client device in accordance with various embodiments of the disclosure is shown. In many embodiments, the process 900 may be implemented in a network device. For example, the network device may include at least one of a firewall or an enterprise DNS monitor.

In several embodiments, the process 900 may receive a first ECH message having a portion encrypted with a first ECH configuration key (block 910). For example, the process 900 may receive the first ECH message having the portion encrypted with the first ECH configuration key from a client device. In an example, the process 900 may receive the first ECH message from the client device when the client device initiates a TLS communication session with an upstream server. For example, the first ECH configuration key may be unknown to the process 900.

In several additional embodiments, the process 900 may transmit a Hello retry message with a second ECH configuration key (block 920). The process 900 may transmit the Hello retry message with the second ECH configuration key to the client device in response to receiving the first ECH message having the portion encrypted with the first ECH configuration key. A decryption corresponding to the second ECH configuration key may be supported at the network device. In an example, the second ECH configuration key may be known key.

In many further embodiments, the process 900 may receive a second ECH message having a portion encrypted with the second ECH configuration key (block 930). The process 900 may receive the second ECH message having the portion encrypted with the second ECH configuration key from the client device. The process 900 may receive the second ECH message in response to transmitting the Hello retry message to the client device.

In yet many embodiments, the process 900 may decrypt the portion using the second ECH configuration key (block 940). The process 900 may decrypt the encrypted portion of the second ECH message using the second ECH configuration key. For example, the process 900 may decrypt the encrypted portion of the second ECH message to analyze the decrypted portion to manage network security. In one or more embodiments, the decryption of the portion using the second ECH configuration key may be optional.

In yet more embodiments, the process 900 may determine that the decrypted portion complies with one or more security policies (block 950). In an example, a security policy may require that the retrieved SNI match a predefined list of trusted domain names. In another example, a security policy may specify that the ALPN field must indicate a supported protocol version to ensure network compatibility and security.

In yet further embodiments, the process 900 may re-encrypt the decrypted portion using the first ECH configuration key (block 960). The process 900 may re-encrypt the decrypted portion of the second ECH message based on the first ECH configuration key. For example, if it is determined that the decrypted portion of the ECH message complies with one or more security policies, process 900 may retrieve the first ECH configuration key from a database. The process 900 may then re-encrypt the decrypted portion of the ECH message based on the retrieved first ECH configuration key. This ensures that the second ECH message remains protected prior to transmission to an intended recipient. Further, the process 900 may generate a modified ECH message having the re-encrypted portion and the first ECH configuration key.

In still yet various embodiments, the process 900 may initiate a proxy with a client device (block 970). For example, the process 900 may transmit the modified ECH message having the re-encrypted portion and the first ECH configuration key to the client device over the initiated proxy. The process 900 may thus ensure that the modified ECH message is sent to the client device securely, facilitating further processing or handling while maintaining the confidentiality of the encrypted information throughout the transmission.

Although a specific embodiment for initiating a proxy with a client device suitable for carrying out the various steps, processes, methods, and operations described herein is discussed with respect to FIG. 9, any of a variety of systems and/or processes may be utilized in accordance with embodiments of the disclosure. For example, the process 900 may disengage the proxy after a configured time period expires. The elements depicted in FIG. 6 may also be interchangeable with other elements of FIG. 1-9 and FIG. 10 11 as required to realize a particularly desired embodiment.

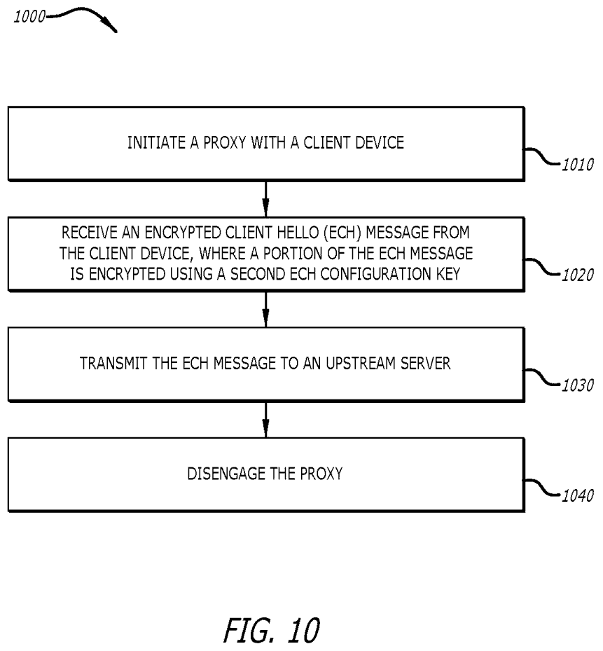

Referring to FIG. 10, a flowchart depicting a process 1000 for transmitting an ECH message to an upstream server in accordance with various embodiments of the disclosure is shown. In many embodiments, the process 1000 may be performed by a network device. For example, the network device may include at least one of a firewall or an enterprise DNS monitor. The network device may be equipped with a security logic for managing encrypted communication protocols for network security.

In many embodiments, the process 1000 may initiate a proxy with a client device (block 1010). In an example, the process 1000 may receive a DNS query from a client device. Further, the process 1000 may initiate the proxy with the client device for the received DNS query. The process 1000 may then receive a DNS response. For example, the reception of the DNS response may be based on the initiated proxy for the received DNS query. The process 1000 may further transmit the DNS response to the client device.

In additional embodiments, the process 1000 may receive an ECH message from the client device, where a portion of the ECH message is encrypted using a second ECH configuration key (block 1020). The process 1000 may receive the ECH message because of the transmitted DNS response to the client device. In an example, the ECH message may be intended for an upstream server. However, the process 1000 may receive the ECH message after it has been intercepted.

In several embodiments, the process 1000 may transmit the ECH message to the upstream server (block 1030). In an example, the process 1000 may optionally analyze the ECH message and trigger a remedial action based on the analysis before transmitting the ECH message to the upstream server. The remedial action may include at least one of connection termination, redirection of the ECH message to a resolver, or flagging a security alert. In one or more embodiments, the process 1000 may transmit the ECH message to the upstream server as part of an ongoing TLS communication session between the client device and the upstream server.

In a variety of embodiments, the process 1000 may disengage the proxy (block 1040). The process 1000 may disengage the proxy with the client device upon the transmission of the received ECH message to the upstream server.

Although a specific embodiment for transmitting an ECH message to an upstream server suitable for carrying out the various steps, processes, methods, and operations described herein is discussed with respect to FIG. 10, any of a variety of systems and/or processes may be utilized in accordance with embodiments of the disclosure. For example, the process 1000 may modify a TTL value in the received DNS response from a first value to a second. In an example, the second value may be less than the first value. The process 1000 may disengage the proxy with the client device based on an expiration of the TTL. The elements depicted in FIG. 10 may also be interchangeable with other elements of FIG. 1-9 and FIG. 11 as required to realize a particularly desired embodiment.

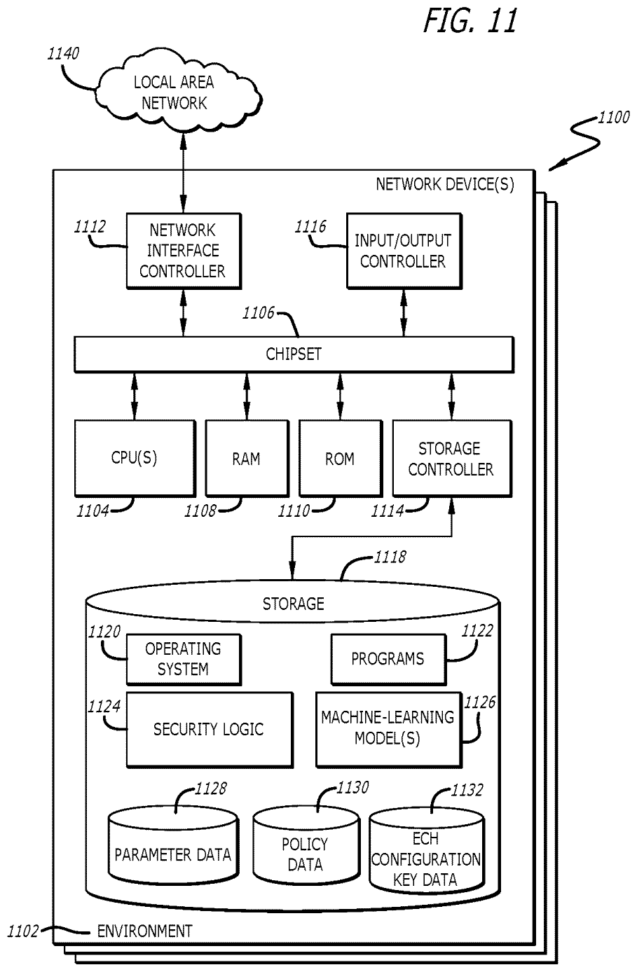

Referring to FIG. 11, a conceptual block diagram of a device 1100 suitable for configuration with a security logic in accordance with various embodiments of the disclosure is shown. The embodiment of the conceptual block diagram depicted in FIG. 11 can illustrate a conventional server, switch, wireless LAN controller, AP, computer, workstation, desktop computer, laptop, tablet, network appliance, e-reader, smartphone, or other computing device, an ethernet interface, and can be utilized to execute any of the application and/or logic components presented herein. The embodiment of the conceptual block diagram depicted in FIG. 11 can also illustrate an AP, a switch, an edge node, an ethernet interface, or a router in accordance with various embodiments of the disclosure. The device 1100 may, in many non-limiting examples, correspond to physical devices or virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100. In several embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in many embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120 and programs 1122 (e.g., applications). The storage 1118 can be connected to the environment 1102 through a storage controller 1114 connected to the chipset 1106. In various other embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In many more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In many examples, the operations performed by a cloud computing network, and/or any components included therein, may be supported by one or more devices like device 1100. Stated otherwise, some or all the operations performed by the cloud computing network, and/or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as programs 1122 (e.g., an application) and transform the device 1100 by specifying how the processor(s) 1104 can transition between states, as described above. In many embodiments, the device 1100 has access to computer-readable storage media storing computer-executable instructions which, when executed by the device 1100, perform the various processes described above with regard to FIG. 1-10. In various embodiments, the device 1100 can also include computer-readable storage media having instructions stored thereupon for performing any of the other computer-implemented operations described herein.

In many further embodiments, the device 1100 may include a security logic 1124. The security logic 1124 can be configured to perform one or more of the various steps, processes, operations, and/or other methods that are described above. The security logic 1124 can be a set of instructions stored within a non-volatile memory that, when executed by the processor(s) 1104 can carry out these steps, etc. In many embodiments, the security logic 1124 may be a client application that resides on a network-connected device, such as, but not limited to, a server, switch, an ethernet interface, personal or mobile computing device in a single or distributed arrangement. The security logic 1124 may be configured to manage encrypted communication protocols for network security.

In many embodiments, the security logic 1124 may be configured to receive a DNS response including a first ECH configuration key. The security logic 1124 may replace the first ECH configuration key in the DNS response with a second ECH configuration key, where a decryption corresponding to the second ECH configuration key is supported at the network device. The security logic 1124 may further transmit the DNS response with the second ECH configuration key.

In further embodiments, the security logic 1124 may receive a first ECH message, where an encryption of a portion of the first ECH message is based on a first ECH configuration key. The security logic 1124 may then transmit a Hello retry message comprising a second ECH configuration key. A decryption corresponding to the second ECH configuration key may be supported at the network device. Further, the security logic 1124 may receive a second ECH message. An encryption of a portion of the second ECH message is based on the second ECH configuration key.

In various embodiments, the storage 1118 can include parameter data 1128. The parameter data 1128 may refer to a plurality of parameters associated with a received DNS response from a DNS server. The plurality of parameters may include a first ECH configuration key and at least one of a domain name, a public name, service binding metadata, or a client identifier specified in the received DNS response. In various embodiments, the storage 1118 can include policy data 1130. The policy data 1130 may refer to one or more security policies used to determine whether a received ECH message is compliant or non-compliant with the one or more security policies. In a number of embodiments, the storage 1118 can include ECH configuration key data 1132. The ECH configuration key data 1132 may include a first ECH configuration key and a second ECH configuration key.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In various examples, the virtualization layer may be supported by a hypervisor that provides one or more virtual machines running on the device 1100 to perform functions described herein. The virtualization layer may generally support a virtual resource that performs at least a portion of the techniques described herein.

Finally, in numerous additional embodiments, data may be processed into a format usable by a ML model 1126 (e.g., feature vectors), and/or other pre-processing techniques. The ML model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126. In an example, the ML model 1126 may include the plurality of classifiers, each trained for a specific task such as error correction and encoding or decoding of one or more data frames transmitted before and after power transitioning phase by the device, that share common encoder(s).

The ML model(s) 1126 can be configured to generate inferences to make predictions or draw conclusions from data. An inference can be considered the output of a process of applying a model to new data. This can occur by learning from at least the parameter data 1128, the policy data 1130, and the ECH configuration key data 1132. These predictions are based on patterns and relationships discovered within the data. To generate an inference, the trained model can take input data and produce a classification result. The input data can be in various forms, such as images, audio, text, or numerical data, network packet data depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes. Further, the ML model(s) 1126 may be configured to process the policy data 1130 based on the ECH configuration key data 1132.

Although a specific embodiment for a device suitable for configuration with a security logic for carrying out the various steps, processes, methods, and operations described herein is discussed with respect to FIG. 11, any of a variety of systems and/or processes may be utilized in accordance with embodiments of the disclosure. For example, the device 1100 may be in a virtual environment such as a cloud-based network administration suite, or it may be distributed across a variety of network devices. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the scope of the present disclosure, as set forth in the appended claims, as might be apparent to those of ordinary skill in the art, are also encompassed by the present disclosure.

What is claimed is:

1. A network device, comprising:
one or more processors; and
a memory communicatively coupled to the one or more processors, wherein the memory comprises a security logic that is configured to:
receive a domain name system (DNS) response comprising a first Encrypted Client Hello (ECH) configuration key;
replace the first ECH configuration key in the DNS response with a second ECH configuration key, wherein a decryption corresponding to the second ECH configuration key is supported at the network device; and
transmit the DNS response with the second ECH configuration key.

2. The network device of claim 1, wherein the security logic is further configured to:
receive an ECH message based on the transmitted DNS response, wherein an encryption of a portion of the ECH message is based on the second ECH configuration key; and
decrypt the portion of the ECH message based on the support for the decryption corresponding to the second ECH configuration key.

3. The network device of claim 2, wherein the security logic is further configured to:
store, in a database, a plurality of parameters associated with the received DNS response, wherein the plurality of parameters comprises the first ECH configuration key and at least one of: a domain name, a public name, service binding metadata, or a client identifier specified in the received DNS response;
retrieve, from the database, the first ECH configuration key; and
re-encrypt the decrypted portion based on the retrieved first ECH configuration key.

4. The network device of claim 2, wherein the security logic is further configured to:
re-encrypt the decrypted portion of the ECH message based on the first ECH configuration key;
replace the encrypted portion in the ECH message with the re-encrypted portion; and
transmit the ECH message having the re-encrypted portion.

5. The network device of claim 4, wherein the security logic is further configured to initiate a proxy connection with an upstream server, wherein the transmission of the ECH message having the re-encrypted portion is to the upstream server over the proxy connection.

6. The network device of claim 4, wherein the security logic is further configured to:
determine that the decrypted portion of the ECH message complies with one or more security policies, wherein the re-encryption of the decrypted portion of the ECH message is based on the determination that the decrypted portion of the ECH message complies with one or more security policies.

7. The network device of claim 2, wherein the security logic is further configured to:
determine that the decrypted portion of the ECH message is non-compliant with one or more security policies; and
trigger a remedial action based on the determination that the decrypted portion is non-compliant with the one or more security policies.

8. The network device of claim 7, wherein the remedial action comprises at least one of: connection termination, redirection of the ECH message to a resolver, or flagging a security alert.

9. The network device of claim 1, wherein the security logic is further configured to:
receive a DNS query from a client device; and
initiate a proxy for the received DNS query, wherein the reception of the DNS response is based on the initiated proxy for the received DNS query.

10. The network device of claim 9, wherein the security logic is further configured to transmit the DNS response with the second ECH configuration key to the client device in response to the received DNS query.

11. The network device of claim 9, wherein the security logic is further configured to:
determine, prior to the reception of the DNS query, that the client device supports an encrypted DNS protocol; and
establish a proxy connection with the client device, wherein the reception of the DNS query is on the proxy connection.

12. The network device of claim 11, wherein the encrypted DNS protocol comprises at least one of DNS over Hypertext Transfer Protocol Secure (DoH) or DNS over Transport Layer Security (DoT).

13. The network device of claim 9, wherein the security logic is further configured to:
modify a time-to-live (TTL) value in the received DNS response from a first value to a second, wherein the second value is less than the first value.

14. The network device of claim 13, wherein the security logic is further configured to disengage the proxy based on an expiration of the TTL.

15. The network device of claim 1, wherein the security logic is further configured to:
receive, from a client device, an ECH message, wherein an encryption of a portion of the ECH message is based on the second ECH configuration key;
transmit the received ECH message to an upstream server; and
disengage a proxy with the client device upon the transmission of the received ECH message to the upstream server.

16. The network device of claim 1, wherein
the received DNS response comprises a first public name, and
the security logic is further configured to:
replace the first public in the received DNS response with a second public name associated with the network device, wherein the transmitted DNS response includes the second ECH configuration key and the second public name.

17. The network device of claim 1, wherein the network device comprises at least one of a firewall or an enterprise DNS monitor.

18. A network device, comprising:
one or more processors; and
a memory communicatively coupled to the one or more processors, wherein the memory comprises a security logic that is configured to:
receive a first Encrypted Client Hello (ECH) message, wherein an encryption of a portion of the first ECH message is based on a first ECH configuration key;
transmit a Hello retry message comprising a second ECH configuration key, wherein a decryption corresponding to the second ECH configuration key is supported at the network device; and
receive a second ECH message, wherein an encryption of a portion of the second ECH message is based on the second ECH configuration key.

19. The network device of claim 18, wherein the security logic is further configured to:
decrypt the portion of the second ECH message based on the support for the decryption corresponding to the second ECH configuration key;
determine that the decrypted portion of the second ECH message complies with one or more security policies;
re-encrypt, based on the determination that the decrypted portion complies with the one or more security policies, the decrypted portion of the ECH message based on the first ECH configuration key;
replace the encrypted portion in the second ECH message with the re-encrypted portion; and
transmit the second ECH message having the re-encrypted portion.

20. A method, comprising:
receiving a domain name system (DNS) response comprising a first Encrypted Client Hello (ECH) configuration key;
replacing the first ECH configuration key in the DNS response with a second ECH configuration key, wherein a decryption corresponding to the second ECH configuration key is supported; and
transmitting the DNS response with the second ECH configuration key.
